(19) United States
(12) Patent Application Publication
(10) Pub. No.: US 2020/0068798 A1
(43) Pub. Date: Mar. 5, 2020

(54) APPARATUS FOR SURFACE IRRIGATION

(71) Applicant: EVERRIS INTERNATIONAL B.V., Heerlen (NL)

(72) Inventor: Masahide TABATA, Chiba (JP)

(21) Appl. No.: 16/116,951

(22) Filed: Aug. 30, 2018

(51) Int. Cl. A01C 23/04; A01M 7/00

(52) U.S. Cl. CPC A01C 23/042; A01M 7/00

(57) ABSTRACT

Apparatus and methods for use in surface irrigation.

### FIELD OF THE INVENTION

The present invention generally relates to fertigation and chemigation systems and methods, and more particularly fertigation and chemigation systems and methods for use in surface irrigation.

### BACKGROUND ART

The delivery of dissolved nutrients to crops using irrigation water is known as fertigation. Chemigation refers not only to delivering nutrients but also to delivering agrochemicals such as biostimulants and pesticides—for example herbicides, insecticides, growth regulators and fungicides—to crops using irrigation water. Fertigation/chemigation systems are developed to combine irrigation and fertilizer/agrochemical application, which is particular important for specific crops and situations where, for example, insufficient water is provided to plants. In fertigation/chemigation systems, nutrients such as fertilizers and/or agrochemicals such as pesticide can be injected into the irrigation network via various methods such as pressure differential, venturi pump, and displacement pump. While conventional fertigation methods are designed to be a viable addition to the means of delivery of nutrients to crops, they are not without some limitations.

Surface irrigation is a traditional irrigation method which are still one of the most commonly used methods of irrigation. Surface irrigation refers to an irrigation system in which a crop field is flooded to a predetermined depth. Surface irrigation systems apply water by gravity flow to the surface of the field. The entire field can be flooded (basin irrigation) or the water can be fed into small channels (furrows) or strips of land (borders). The fertigation techniques are rarely adopted for surface irrigation, resulting in a reduction in nutrients yield/quality, an increase in nutrients runoff and non-uniform delivery of nutrients to the field.

There are, however, primitive fertigation methods used for surface irrigation. For example, one method includes measuring the amount of necessary fertilizers to be delivered to a crop, and placing the fertilizers at the water inlet point of the flooded field. The water stream generated from the water inlet diffuses nutrients all over the flooded field as time proceeds. Although this method is simple to operate and economical, it can't achieve uniform delivery of nutrients to field.

A tank discharging system (for example see JP patent publication number 1999-018533 to Masaru Kubota) is based on the principle of free fall of drops discharged from a single faucet installed at lower side of the tank which encloses dissolved nutrients. The discharged drops fall onto the surface of water at the water inlet point of the flooded rice field. The flow rate of drops can be adjusted by opening position and/or inner diameter size of the faucet, and is influenced primarily by height of fluid level in the tank and not by height of the tank, thereby becoming lower gradually with the decreasing height of fluid level. However, this system is not as accurate as micro fertigation systems because, for example, the fluid dosing rate is not proportion over the entire period of surface irrigation.

A float valve regulated emitter (for example see JP patent publication number 2017-77210 to Tsuneo Onodera, et al.) proposes proportional fluid dosing rate for surface irrigation to rice field. This system is complicated and its moving components are prone to wear and tear. There is a need to improve uniform delivery of nutrients to the crop field.

The most commonly used method for applying fertilizers to the entirely flooded crop fields such as paddy rice field is by broadcasting solid granular fertilizers onto surface of ground by hand or knapsack applicator with or without power during growing season. Highly skilled workers are needed to achieve even distribution of nutrient. Nevertheless, comparatively even nutrient distribution per plant is not easily achievable, especially when amount of applied fertilizers is comparatively low per unit area. That is because some plants are distant to an applied granular fertilizer and others are less distant due to thinly scattered fertilizers. Physiologically, it is more ideal to divide number of fertilizer applications to crops over growing season without changing total dosage. However, as stated above, it is difficult to apply low amount of fertilizers evenly and it is time-consuming to apply fertilizers frequently by broadcasting solid granular fertilizers.

A gravity drip irrigation system is known as the micro-irrigation method, which doesn't require pressurized water source or external power to pressurize irrigation water, but uses gravitational energy to drive irrigation water from an elevated reservoir to crops via irrigation system. It is recommended to elevate the reservoir tank by more than 1.0 meter to generate enough pressure to cover small-scale field up to 500 square meters. For a gravity drip irrigation system to cover as large field as possible up to 500 square meters, drip line length needs to be maximized, however, the reservoir tank elevation below 1.0 meter can't maximize the drip line length due to undesirable pressure drop in the end of the drip line. There is a trade-off relationship between size of field to be covered and elevation of the reservoir tank for the gravity drip irrigation system.

In addition, more than hundreds of drip emitters per 500 square meters are usually located for the gravity drip irrigation system for a drip emitter to supply water to a plant or a few plants. If more plants are covered by a drip emitter, more uneven water distribution results in unfavorable agronomic characteristics.

The main purpose of the gravity drip irrigation or micro-irrigation system is to deliver water to crops. Highly concentrated nutrient solution is not delivered by the gravity drip irrigation system because it is toxic to crops.

Thus, there is an existing need in the nutrients and agrochemicals delivery field for an economical, accurate to operate and to install apparatus for use in fertigation and/or chemigation, in particular for use in surface irrigation, more particularly for use in basin irrigation, for example, fertigation and/or chemigation of paddy rice fields, which overcome the disadvantages mentioned above.

It is also desirable to design an apparatus that diffuses nutrients and/or agrochemicals efficiently at various flooded crop fields having variable sizes and growth stage of crops.

It is also desirable to design an apparatus that its reservoir tank containing nutrients and/agrochemicals are placed at a low elevation from the surface irrigated field.

It is also desirable to design an apparatus that are less prone to clogging and disturbance during operation.

It is also desirable to design an apparatus that are accurately operated during fertigation and/or chemigation, which can achieve even nutrient and agrochemical distribution per plant, even when amount of applied fertilizers or agrochemicals is comparatively low per unit area.

It is also desirable to design an apparatus that is distinguished from the gravity drip irrigation system, enabling lower elevation of the reservoir tank, much smaller number of emitter means per unit area of field and highly concentrated nutrient solution or suspension to be enclosed in the reservoir tank and to be delivered to the surface irrigated field.

The present invention provides such dosing apparatus and methods to solve one or more of the problems mentioned above. Other features and advantages of the invention will be apparent from the following description and from the claims.

### BRIEF DESCRIPTION OF THE DRAWINGS

The features and advantages of the invention will be appreciated upon reference to the following drawings, in which:

FIG. 1 and FIG. 2 are a plan view and a perspective view of an embodiment of the invention showing the apparatus which emitter means is online dripper and is located above water.

FIG. 3 is an enlarged view of an embodiment of the invention showing the apparatus dosing a liquid composition via online drippers onto the surface irrigation water.

FIGS. 4-6 are views of another embodiment of the invention showing the apparatus which emitter means are integral drippers and are immersed in the irrigation water.

### DESCRIPTION OF THE REFERENCE SYMBOLS

(1) reservoir tank

(2) stand frame

(3) outlet connection

(4) filter

(5) valve

(6) tee connection

(7) air release valve

(8) fluid tube

(9) emitter means

(10) drip conduit

(11) drip guide peg

(12) end cap

(13) water inlet point

(14) flooded field

(15) irrigation water

### DESCRIPTION OF ILLUSTRATIVE EMBODIMENTS

The foregoing and other aspects of the present invention will now be described in detail. The detailed description set-forth below is provided to aid those skilled in the art in practicing the present invention. However, the invention described and claimed herein is not to be limited in scope by the specific embodiments herein disclosed because these embodiments are intended as illustration of several aspects of the invention.

The embodiments set-forth below can be performed and combined with other disclosed embodiments according to the invention. Any equivalent embodiments are intended to be within the scope of this invention. Indeed, various modifications of the invention in addition to those shown and described herein will become apparent to those skilled in the art from the foregoing description which do not depart from the spirit or scope of the present inventive discovery. Such modifications are also intended to fall within the scope of the appended claims.

All publications, patents, patent applications and other references cited in this application are incorporated herein by reference in their entirety for all purposes to the same extent as if each individual publication, patent, patent application or other reference was specifically and individually indicated to be incorporated by reference in its entirety for all purposes. Citation of a reference herein shall not be construed as an admission that such is prior art to the present invention.

In one aspect of the present invention, an apparatus for dispensing a liquid composition is provided. In one embodiment, the apparatus according to the present invention comprises a reservoir tank arranged to dispense the liquid composition to an emitter means, wherein the emitter means is designed, arranged, controlled and/or programmed to dispense the liquid composition at a flow rate determined based upon a parameter or series of parameters. These parameters include, but not limited to, total flow rate of the liquid composition per hour dispensed from total emitter means of the apparatus in operation; number of emitter means; viscosity coefficient of the liquid composition; operating pressure of emitter means; density of the liquid composition; gravity constant, total height; volume of the reservoir tank, dispensing time or any combinations of these parameters.

As used herein, the term “apparatus” may include any component or group of components described herein. The apparatus may also include any apparatuses, components, or the combination thereof. For example, the apparatus includes combination of the reservoir tank and the emitter means (e.g. online and/or integral dippers). Accordingly, the terms “apparatus” and “system” can be used interchangeably.

As used herein, the term “liquid composition” refers a solution or suspension of a product or mixture of two or more products in a liquid medium or a solvent such as water. Optionally, the solution could be replaced by a suspension in which solid particles are finely dispersed in the solvent. Optionally, the mass percent concentration (w/w) of the products (e.g. fertilizer and/or agrochemicals) in the liquid medium or solvent (e.g. water) inside the reservoir tank is at least about 5%, optionally at least about 10%, optionally, between about 10-50%. Optionally, at least 50 g, 60 g, 70 g, 80 g, 90 g, or optionally 100 g of the product per liter are present in the reservoir tank. Optionally, the dilution ratio of the liquid composition to immersion water used for surface irrigation is at least 100, optionally, at least 1000.

As used herein, the team “concentration” refers to a measure of an amount of a product, such as a fertilizer and/or agrochemical as discussed herein, contained per unit volume of the liquid medium or solvent such as water. For example, the weight/volume percentage concentration (w/v) refers to the mass or weight (e.g. in grams) of a fertilizer per volume (e.g. in L) of the liquid medium or solvent present inside the reservoir tank. The mass percent concentration (w/w) refers to mass of a product such as a fertilizer and/or agrochemical per mass of the liquid medium or solvent.

The term “a product” used herein may also include mixture or blend of products.

The product of present invention can be selected from fertilizers, pesticides—such as biocides, herbicides, fungicide,—wetting agents or biostimulants, other plant growth-, health-, proliferation- or development-enhancing products, minerals, chemicals, salts, or any combination thereof. The fertilizers can be selected from water-soluble fertilizers, in particular, containing any macronutrient such as nitrogen, phosphorous or potassium. In one embodiment, the fertilizers of present invention are soluble fertilizers such as urea, urea phosphate, ammonium sulfate (AS), monoammonium phosphate (MAP), diammonium phosphate (DAP), monopotassium phosphate (MKP), Pekacid (US patent publication number U.S. Pat. No. 9,278,890 to Talia Aviv, et al.), Magphos, ammonium nitrate, potassium chloride (KCl), potassium sulfate and potassium nitrate. The “product” or “products” of present invention refers to solid, powder, granule, and/or tablet forms used in treatment of the matter.

The term “dosing” as used herein should be understood generally as providing measured quantities of the liquid composition into the surface irrigated water.

As used herein, the term “reservoir tank”, “tank”, and the like refers to any rigid or semi-rigid tank arranged to receive, to store and/or to dispense the liquid composition of the present invention. Other synonymous to a reservoir tank are tank, container, drum, reservoir, and the like. The reservoir tank of present invention can have any size, shape, and capacity and can be made of any material, optionally, non-corrosive material such as stainless steel, plastic resin, in particular, PE (polyethylene) or PVC. Optionally, the reservoir tank is a 30 L-1500 L rigid plastic tank. Optionally, the height of the reservoir tank is 30 cm-120 cm. Optionally, the reservoir tank can be flexible such as a bag. Optionally, the reservoir tank comprises a heat control layer (e.g. electronic heat jacket) to control and adjust the temperature inside the reservoir tank. Optionally, the reservoir tank has fluid level gauge to see amount of liquid composition left in the reservoir tank. Optionally, shape of the reservoir tank can be wider and shorter to adjust the height of the liquid composition therein. Optionally, the reservoir tank is configured to store and/or dispense exclusively (only) the liquid composition of the present invention. Optionally, the irrigation water does not flow inside the reservoir tank.

In one embodiment, the apparatus, particularly, the reservoir tank is arranged not to receive a continuous supply of the irrigation water during operation, but to receive a batch supply of the liquid composition into the reservoir tank before operation or to receive a batch supply of a solvent/liquid medium and a product into the reservoir tank before operation. Before operation means the apparatus is not in an operational mode and the liquid composition cannot be dispensed to irrigation water via the apparatus. Optionally, the batch of liquid composition is prepared outside of the reservoir tank, e.g. the product and the solvent are mixed and prepared before placed in the reservoir tank. Optionally, the product and the liquid medium or solvent are prepared and mixed inside the reservoir tank.

The term “batch”, for example in batch supply of liquid composition or batch supply of a product, refers to a specific quantity of liquid composition, liquid medium/solvent or product.

As used herein, the terms “emitter means”, “emitter”, “emitter device” and the like are used interchangeably and refer to anything that delivers a liquid composition or any device or structure that the liquid composition is able to flow through its structure. The emitters are arranged to deliver the liquid composition in a reservoir tank to the surface irrigated field such as basin irrigated rice field at a particular flow rate at a given pressure. The emitters include, but not limited to, online drippers, integral drippers, flag emitters, injection nozzles, spray nozzles, open orifices, etc. Optionally, the apparatus comprises one, two, three, four, five, six, seven, eight, nine, ten, eleven, twelve, thirteen, fourteen, fifteen, sixteen, seventeen, eighteen, nineteen or twenty emitter means, for example, on-line drippers and/or an integral dripper. Optionally, the apparatus contains emitter means having the same flow rate at a given pressure. Optionally, the apparatus contains emitter means having different flow rates at a given pressure. Optionally, the apparatus comprises of various of different emitter means, for example combination of online drippers and integral drippers or combination of online drippers and orifices having various or similar sizes and/or flow rate.

In one embodiment, the apparatus is configured to dispense a liquid composition to irrigation water for use in surface irrigation, said apparatus comprises a reservoir tank having the liquid composition to be dispensed therein; wherein the reservoir tank comprises an outlet connection in communication with an emitter means; wherein the reservoir tank, the emitter means, and the apparatus are configured to dispense only the liquid composition. The apparatus is configured in a way where it does not and cannot provide irrigation water to crops and plants. For example, the irrigation water which used for surface irrigation cannot flow into the reservoir tank and the emitter means such as online and integral cannot dispense irrigation water. The term “irrigation water”, as used herein, refers to water which is used to supply the water requirements of any living or growing vegetation, foliage, trees, plants, crops such as rice, shrubs, weeds, grass, which is not provided for by the reservoir tank and emitter means according to present invention. In this embodiment, the irrigation water does not flow inside the reservoir tank containing the liquid composition. The irrigation water is supplied or being supplied via a different or a separate device for surface irrigation of, for example, paddy rice field. For example, the irrigation water can be provided via municipal water supply line. Optionally, the emitter(s) is arranged exclusively for supplying the liquid composition comprising the product of present invention, e.g. fertilizer, nutrients and/or agrochemicals stored in the reservoir tank, thus only a limited number of emitter means are needed for an apparatus of the present invention.

In one embodiment, the emitter means (e.g. on-line drippers and/or integral drippers) are in communication with the reservoir tank, wherein the emitter means are designed, arranged and/or programmed to dispense the liquid composition at a flow rate of the liquid composition (pre)determined based upon one or more parameters comprising volume of the reservoir tank, number of emitter means having specific flow rates at a given pressure or volume of the reservoir tank and total flow rate of emitter means. For example, if the volume of a liquid composition in the tank is 50 L, 8 online drippers having flow rate of 1 L/H is used.

In one embodiment, the emitter means (e.g. on-line and/or integral drippers) are in communication with the reservoir tank, wherein the emitter means are designed, arranged and/or programmed to dispense the liquid composition at a flow rate of liquid composition (pre)determined based upon one or more parameters comprising total height of the liquid composition within the reservoir tank, flow rate of water per emitter means at given pressure, number of emitter means, and dispensing time. For example, if surface irrigation time is 5 hours to fill sufficient water into the rice field, the dispensing time is also 5 hours. If 50 L of fertilizer solution is needed and the emitter mean with 1 L/H flow rate is used, it can be determined that 10 emitters are needed.

In one embodiment, the apparatus is programmed, designed, arranged, monitored, controlled, and/or adjusted to introduce the liquid composition at a flow rate of liquid composition determined based upon characteristics comprising total height, number of emitter means, viscosity coefficient, gravity constant and volume of liquid composition in the reservoir tank. Thereby, users of the apparatus of present invention are able to forecast dispensing time and/or the volume of the liquid composition needed in order to synchronize irrigation time with dosing the liquid composition of the product. For example, if a user selects 10 emitters with 1 L/H flow rate, the user will know 50 L of fertilizer solution is dispensed for 5 hours.

In one embodiment, the dosing apparatus of present invention accordingly to any of the preceding embodiments is monitored, controlled, designed and/or configured to have a flow rate determined by Formula 1:

Fₜ=F₁×V₁+F₂×V₂ . . . +Fₙ×Vₙ (I)

Wherein,

“Fₜ” is a total flow rate of the liquid composition per hour dispensed from total emitter means of the apparatus in operation;

“F₁” is a flow rate per hour of the first emitter mean for water at a given pressure;

“V₁” is viscosity coefficient of the first emitter mean for the liquid composition;

“F₂” is a flow rate per hour of the second emitter mean for water at a given pressure.

“V₂” is viscosity coefficient of the second emitter mean for the liquid composition.

“Fₙ” is a flow rate per hour of n^{th} emitter mean for water at given pressure;

“Vₙ” is viscosity coefficient of the n^{th} emitter mean for liquid composition.

As shown in Formula 1, the flow rate of the emitter is determined by the pressure of the liquid composition on the emitter. The pressure is simply a function of the column height of the liquid composition. Optionally, the pressure losses in the piping and filters can be ignored if the piping and filter are properly designed and dimensioned. The given pressure for each emitter means can be determined by the Formula II:

P=D×g×H (II)

Wherein,

“P”=operating pressure of the emitter means (in Pa);

“D”=Density of the liquid composition (in kg/m³);

“g”=gravity constant (typically 9.8 m/s²)

“H”=total height (in m)

wherein if the emitter means is located outside of irrigation water, the total height is a perpendicular distance between surface of the liquid composition in the reservoir tank and the emitter means, measured along a line that is perpendicular to both, or

if the emitter means is immersed in irrigation water, total height is a perpendicular distance between surface of the liquid composition in the reservoir tank and surface of irrigation water, measured along a line that is perpendicular to both.

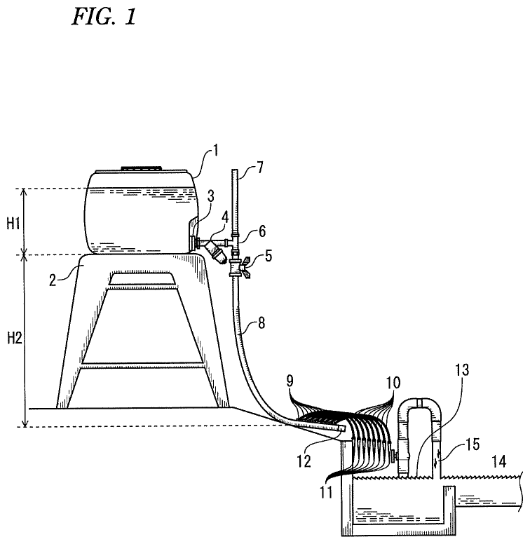

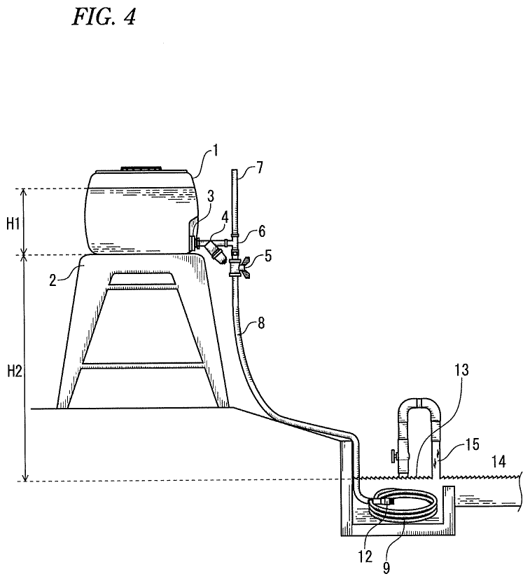

Optionally, as shown in FIG. 1 and FIG. 4, the total height is H1+H2, wherein H1 is the height of the liquid composition in the reservoir tank and H2 is the perpendicular distance between the bottom surface of the reservoir tank and the emitter means (if emitter means located outside of the irrigation water) or the surface of irrigation water (if emitter means is immersed in the reservoir tank).

Optionally, H2 is about 70 cm or higher than 70 cm. The higher H2 is, the smaller number of emitter means is required. When H2 is much lower than 70 cm, sufficient pressure is not created to let emitter means work correctly and stably because flow rate per hour is too low. When more than 70 cm elevation is obtained topographically, stand frame is not necessary. Moreover, it is preferable that H2 is more than two times higher than H1. If H2 is less than two times of H1, flow rate at beginning of fertigation and that at end of fertigation has too wide gap to distribute nutrients evenly at the surface irrigated land over dispensing time. Therefore, not to create the wide gap in terms of flow rate, it is preferable that H1 is lower than ½ of H2.

Preferably, the maximum H2 is 50 meters. At the hilly region where topographical elevation is available, it is possible to place the reservoir tank at 50 meters elevated point from emitter means or surface water level of flooded field. But comparatively high pressure is created by more than 50 meters elevation and then it is not possible to adjust flow rate by changing number of emitter means. Moreover, more than 50 meters length of fluid tube can hold substantially extra liquid composition even after the tank gets empty. The flow rate of fertigation is decreased gradually for comparatively long time until the extra liquid composition left in the more than 50 meters length of fluid tube gets empty. That also creates too wide gap to distribute nutrients evenly at the surface irrigated land over dispensing time.

As used herein, the term “stand frame”, “stand” or “platform” refers to a means (e.g., a device) to elevate the reservoir tank artificially from emitter means or surface water level of flooded field (surface of irrigation water), in case topographical elevation is not available or sufficient to generate about 0.070 bar. optionally, the stand is a separate component from the reservoir tank. optionally, height of stand is adjusted to make total height of about 70 cm or higher. optionally, the major axis of stand is oriented perpendicular to the ground surface. optionally, the top aspect of stand is oriented parallel to the bottom aspect of the reservoir tank. optionally, the stand has a capacity to load weight of liquid composition and the reservoir tank. optionally, the stand has telescopic legs which makes the top aspect of stand level even on the sloped ground surface.

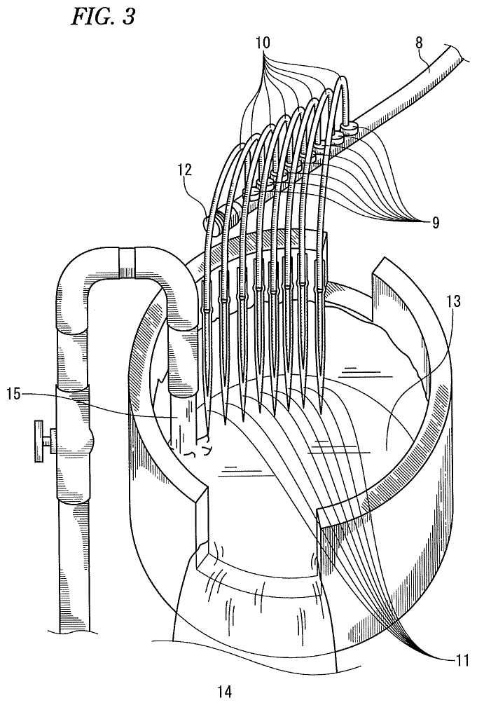

In further embodiment, referring to FIGS. 1-3, the emitter means (9) are online drippers and are located below the reservoir tank (1). The emitter means (9) are connected to the outlet connection (3) of the reservoir tank (1) via, optionally, fluid tube (8) to introduce the liquid composition onto the irrigation water (15) used for surface irrigation of field (14). As the liquid composition is dispensed onto the irrigation water by the emitter means (9) having a flow rate specifically calculated for desired dosing time. Optionally, the apparatus includes a valve (5) to control, close or open the flow of the fluid through and a filter (4) in order to eliminate foreign particles and insoluble matters which are larger than passage of emitter means (9).

In further embodiment, referring to FIGS. 1-3, the drip conduit (10) of present invention are in contact with drip guide pegs (11) in order to guide drips of liquid composition onto matter with absolute accuracy and to prevent interference by other emitter means and/or natural barriers from closing outlets of emitter means. The unexpected wind or twist of dripper means can block the flow from outlets of emitter means and can reduce flow rate unexpectedly.

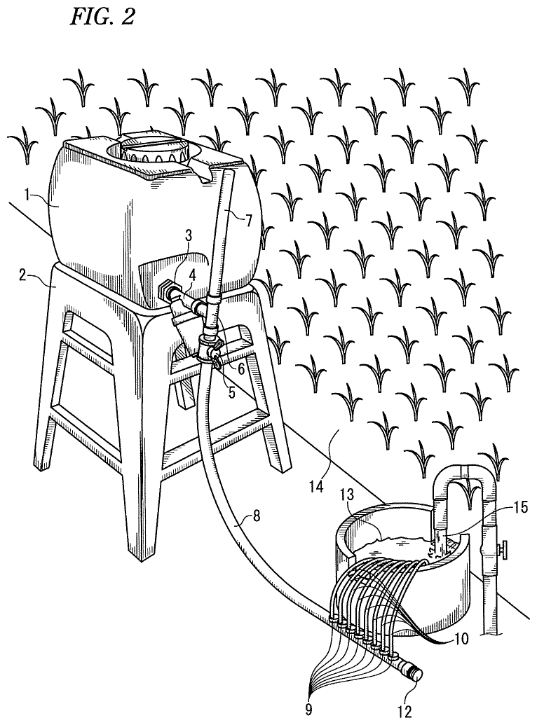

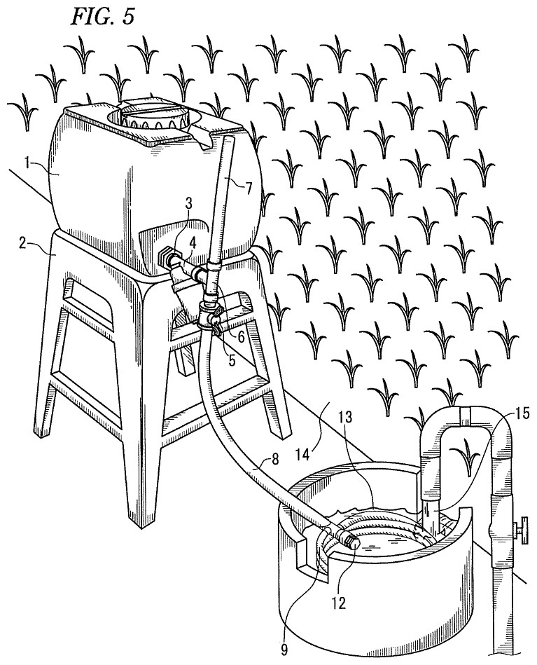

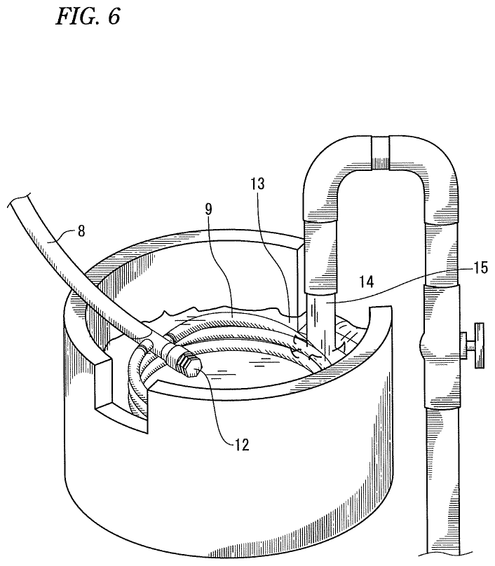

In further embodiment, referring to FIG. 4-6, integral dripper as the emitter means (9) has looped end to place optionally at a point where the strongest irrigation water stream is generated at the surface irrigation field such as basin irrigation rice field. In further embodiment, referring to FIG. 2, integral drippers as the emitter means (9) is immersed in the irrigation water to prevent clogging trouble which can be caused by direct contact with external air and frequent cleaning of drip emitters. In further embodiment, integral drip line as the emitter means (9) has multiple drip outlets which promotes diffusion of nutrients.

In further embodiment, the emitter means (9) of present invention comprises a fixing means to prevent float and movement. The fixing means can be a weight to prevent float or a peg to prevent movement.

In further embodiment, the emitter means (9) is designed to dispense the liquid composition by gravity, for example when it is outside and/or immersed in the irrigation water.

The optional filter (4) as shown in the figures can have any shape, optionally, cylindrical shape, can have any size as long as the flow rate of the sum of the emitter means passes through continuously, without a delay and can be made of any material, optionally, not-corrosion sensitive material such as stainless steel, plastic resin, in particular, PE (polyethylene) or PVC. The filter of present invention may be of any type, optionally, surface filter such as screen, disc, textile, membrane or any combination thereof. Optionally, the filter surface can be replaceable and/or disposable. For the current invention, it is assumed that the filter does not create a significant pressure drop.

As used herein, the term “outlet (3)” or “outlet connection” refers to a means (e.g., a device) where a liquid composition exits the reservoir tank. In one embodiment, the outlet is a separate component from the reservoir tank. In one embodiment, the major axis of outlet is oriented perpendicular to the major axis oft the reservoir tank. In another embodiment, the major axis of outlet is oriented parallel to the major axis of the reservoir tank. In one embodiment, the outlet is in the form of a tube. In another embodiment, the outlet is in the form of a pipe. Optionally, the outlet is made of any not corrosion sensitive material, optionally, any non-corrosive material. Optionally, the outlet is a 25 mm PVC pipe or 25 mm PE pipe.

As used herein, the terms “fluid tube (8)” refers to a mean in the form of pipe, where a liquid composition is in communication with outlet connection and emitter means. Optionally, the fluid tube is made of any material, optionally, any not corrosion sensitive material. Optionally, the fluid tube is a PE pipe which outer diameter is 25 mm and inner diameter is 21 mm. In another embodiment, fluid tube has bent side which angle is blunt for the air to float up naturally.

As used herein, the terms “drip conduit (10)” refers to a mean in the form of, for example, a pipe, where a liquid composition is in communication with emitter means. Optionally, the drip conduit is made of any material, optionally, any not corrosion sensitive material. Optionally, the drip conduit is a PVC pipe microtube which outer diameter is 5 mm and inner diameter is 3 mm.

As used herein, the terms “drip guide peg (11)” or “guide peg” refers to a mean to fix outlet of the drip conduit as a hook and/or a clip and to direct drips of the liquid composition to a water inlet point of flooded filed. The drip guide peg is in contact with drip conduit which is in communication with emitter means. In one embodiment, the drip guide peg is a separate component from drip conduit. In one embodiment, the drip guide peg has a pointed end. In one embodiment, the drip guide peg has a posterolateral groove and/or longitudinal rib which prevents outlet of the drip conduit from being blocked by external obstacles. Optionally, the drip guide peg is made of any material, optionally, any not corrosion sensitive material. Optionally, the drip guide peg is made of plastic.

The optional valve (5) can be placed before the filter. In one embodiment, the valve (5) can be replaced with the pinch valve which is controlled electrically and operated remotely.

In further embodiment, the apparatus of present invention comprises an air release tube (7) placed outside of the reservoir tank and is in communication with outlet of reservoir tank (1) not to allow air entrainment into the fluid tube (8) and emitter means (9). Optionally, the air release tube (7) can be made of transparent material and it can be used as liquid level gauge of the reservoir tank (1) and is in communication with the reservoir tank (1) and fluid tube (7), which also works as an air release valve. To promote air release via the air release tube (7), it is preferable that the fluid tube (8) doesn't have a bending with 90 degrees or acute angle, but it has a bending with obtuse angle or curvature.

An example of on-line drippers as emitter means that can be used in the apparatus are the online drippers having predetermined flow rates at a given pressure according to table 1:

PRESSURE (BAR)

| | 0.1 | 0.2 | 0.4 | 0.6 | 0.8 | 1.0 |
|---|---|---|---|---|---|---|
| FLOW RATE (L/H) | 1.1 | 2.0 | 2.6 | 3.2 | 3.6 | 4.0 |

An example of integral drippers as emitter means that can be used in the apparatus are the integral dripper having predetermined flow rates at given pressures according to table 2:

| | PRESSURE (BAR) | | | | | |
|---|---|---|---|---|---|---|
| | 0.1 | 0.2 | 0.4 | 0.6 | 0.8 | 1.0 |
| FLOW RATE (L/H) | 0.65 | 0.91 | 1.28 | 1.56 | 1.79 | 2.00 |

There are various commercially available online drippers (e.g. Rivulis™'s E1000) and integral drippers (e.g. Netafim™'s Microdrip 8 mm). The apparatus according to present invention, in one embodiment, configures and adjusts the known commercially available emitters such as Rivulis E1000™ and Netafim's Microdrip 8 mm based several parameters including volume of the reservoir, which is arranged to deliver fertilizers and/or agrochemicals for use in fertigation and/or chemigation of surface irrigation fields, in particular for use in basin irrigation, more particularly for use basin irrigation of paddy rice.

Optionally, the emitter means of present invention dispense the liquid composition at comparatively low pressure such as about 0.05 bar, which means that minimum elevation of tank (e.g. H2 as shown in the figures) of about 50 cm is needed. Optionally, the emitter means dispense the liquid composition at pressure from about 0.05 bar to about 5.0 bar and optionally, the emitters have flow rate drop from about 0.1 bar to about 0.070 bar. Optionally, the emitter means dispense the liquid composition at the pressure of about 0.07 bar, which means that minimum elevation of tank of about 70 cm is needed.

In one embodiment, on-line drippers as emitter means are in communication with a fluid tube and drip conduit. In another embodiment, integral dripper line as emitter means is in communication with fluid tube.

For example, referring to table 1, flow rate of water per emitter is 1.1 L/hour at 0.1 bar which is achieved by total height is 0.98 meter and 8 pieces of emitters are needed for the dosing apparatus to achieve 8.8 L/hour of flow rate of the liquid composition, in case viscosity coefficient of the liquid composition is 1.0 and density of the liquid composition is 1.0

As used herein, the term “viscosity coefficient” and the like refers to the index of factor which means how much flow rate is reduced by the viscosity of a liquid composition compared to the viscosity of water for a certain type of emitter means. While there are emitter means which are not sensitive to viscosity of liquid composition, there is a certain type of emitter means which are sensitive to viscosity of liquid composition. In case the emitter means is on-line dripper or any other means with viscosity sensitivity, “viscosity coefficient” is pronounced. The index of “viscosity coefficient” is empirically calculated and the index ranges from 0 to 1.0. For example, if the flow rate of water of an emitter is 0.65 L/hour and the flow rate of a liquid composition of the emitter is 0.36 L/hour, then the viscosity coefficient of the liquid composition is 0.36/0.65=0.55.

As used herein, the term “density” refers to weight of a volume of a liquid composition.

As used herein, the term “matter”, “matters”, and the like refers to a surface irrigation field having any living or growing vegetation, foliage, trees, plants, crops such as rice, shrubs, weeds, grass, fungi and insects. In one embodiment, the matter is a basin irrigation rice field, optionally, a 0.3-2.0 hectare of basin irrigated rice filed. The matter can also refer to the irrigation water. The irrigation water can be at the inlet point of a field and/or can be a flowing irrigation water.

As used herein, the term “treatment of a matter”, “treating the matter”, and the like includes fertigation/chemigation for promoting growth or yield, fertilization, nutrient feeding, insect control, pesticide-, herbicide-, bactericide-, fungicide-application, and improving or altering ornamental or appearance of the matter.

As used herein, the term “water-soluble” refers to a product that is capable of being dissolved in a given amount of water at a given physical condition such as temperature. Generally, the term “water-soluble” refers to a partially or completely dissolved form. For example, a product or mixture of products (e.g. fertilizer(s)) can be present in dissolved form, wherein it is dissolved to an amount of over 80%, preferably over 90%, and more preferably over 95%, and most preferably over 99%. Optionally, the product or mixture of the products is 100% dissolved.

The term “in communication with” encompasses a physical connection that may be direct or indirect through another material or layer between one component of the system and another. For example, the outlet connection and the emitter means of present invention are designed to be in communication with each other.

As used herein, the term “solubility” refers to the maximum amount of a product of present invention that can be dissolved in a given quantity of fluid such as water at a given temperature. For example, the measure of solubility of a product at a given temperature is how many grams of the product can be dissolved in each 100 g of the specific fluid to form a saturated solution.

As used herein, the term “flow rate” includes the ability of the programmed, controlled, designed, or configured dripper emitter means according to the present invention to maintain a preselected setpoint flow rate over time, with a relatively small plus or minus variance from the exact set point flow rate, e.g., plus or minus 1-10%. For example, the flow rate of 8 liter per hour includes +/−10%, or from 7.2 liter per hour to 8.8 liter per hour. The preselected setpoint flow rate is determined based upon characteristics comprising total height, flow rate of water per dripper emitter at given pressure, number of emitter means, viscosity coefficient, specific gravity and dosing time.

The terms “dosing time”, “dispensing time”, “operation time”, “fertigation time” or the like are used interchangeably and refer to the designated period of time for dispensing the liquid composition out of the reservoir tank via emitter means, in particular, from the reservoir tank to the matter. For example, In one embodiment, the dispensing time of present invention is 4-8 hours. It is ideal to synchronize irrigation time to get enough standing water height with dosing time.

Moreover, for the purposes of the present invention, the term “a” or “an” entity refers to one or more of that entity unless otherwise limited. As such, the terms “a” or “an”, “one or more” and “at least one” can be used interchangeably herein.

In another aspect of present invention, a method for dispensing a liquid composition to a matter and/or irrigation water is provided. The method of present invention is particularly used for fertigation, chemigation and/or irrigation. All of the preceding embodiments apply and are incorporated by reference in their entirety into this embodiment.

In one embodiment, the method comprises dispensing the liquid composition to the matter and/or irrigation water via the apparatus according to any of the preceding embodiments. Optionally, the method comprises placing emitter means (e.g. online and/or integral drippers) outside of the irrigation water used for surface irrigation, in particular basin irrigation of paddy rice field. Optionally, the method comprises placing emitter means (e.g. online and/or integral drippers), wherein the emitter means are on the surface of the irrigation water used for surface irrigation. Optionally, the method comprises placing emitter means (e.g. online and/or integral drippers) submerged or immersed in the irrigation water use for surface irrigation.

In one embodiment, the method comprises dispensing a liquid composition comprising (or consisting of) fertilizer(s) and/or agrochemicals to the matter (e.g. paddy rice) or to the irrigation water via emitter means (e.g. online and/or integral drippers).

In another aspect of present invention, use of the apparatus according to any of the preceding embodiments for surface irrigation, particularly for fertigation and/or chemigation of flooded surfaces (surface irrigation including basin, border, furrow irrigated fields) is provided. Optionally, the apparatus according to any of the preceding embodiments is used for fertigation and/or chemigation of surface irrigated (e.g. basin irrigated) crop fields such as paddy rice; pastures (e.g. alfalfa, clover); trees (e.g. citrus, banana); crops which are grown at broadacre filed (e.g. cereals); to some extent row crops such as tobacco. In general, the apparatus according to any of the preceding embodiments can be used for dispensing a product (e.g. fertilizers and agrochemicals such as pesticides) to the irrigation water used for surface irrigation where crops can stand flooded surface for periods longer than 24 hours.

In one embodiment, the term “comprising” in any of the embodiment of present disclosure is replaced with the term “consisting of” or “consisting essentially of”.

In one embodiment, the apparatus according to any embodiment of present disclosure includes the irrigation water, i.e. the system or apparatus includes the irrigation water (15) used for surface irrigation as shown in the figures. Optionally, the apparatus/system configured to dispense a liquid composition to irrigation water for use in surface irrigation, said system/apparatus comprises a reservoir tank, a emitter means and irrigation water, wherein the liquid composition is dispensed or stored in the reservoir tank; wherein the reservoir tank comprises an outlet connection in communication with an emitter means, wherein the reservoir tank, the emitter means, and/or the apparatus are configured to dispense only the liquid composition to the irrigation water. All the embodiments of the present disclosure can be incorporated entirely into this embodiment, e.g. embodiments concerning emitter means, apparatus, reservoir tank, their flow rates, H1, H2, total height, type of emitter means, emitter means dispensing rate, pressure, etc.

### EXAMPLE

A single application of bulk blend fertilizers containing controlled-release fertilizer (CRF, mainly Polymer Coated Urea) as base application before transplanting or sowing has been widely used for rice production in Japan since the mid-80s. It is a high-intensity labor to wade through muddy rice field under the blazing sun while shouldering a 30 kg knapsack applicator for a top-dressing. CRF blended in the base fertilizer replaces the labor of multiple top-dressing applications and has become the major nitrogen nutrient management in Japan. While this single-application technique has been widely accepted, the importance of on-demand top-dressing regains the spotlight because of recurrent high-temperature injury during grain-filling period, cost-consciousness of large-scale rice growers and development of remote sensing technology. However, there is no inexpensive labor or technique to provide multiple top-dressing solution. The apparatus, its use and the method of present disclosure according to any of the embodiments provides fertigation in rice. The system enables, for example, the solution of water-soluble fertilizers (nitrogen, phosphate and potassium) at a water inlet point out of the field and supplies the solution continuously through irrigation to the rice field.

Materials and Methods for a Trial Held

Site: Ryugasaki-shi, Ibaraki prefecture, Japan

Soil type: Peat soil

Size of treatment field (fertigation): 0.34 ha (79 m×45 m)

Rice cultivar: Akidawara

Planting density (intra row 30 cm×intra plant 20 cm)

Fertigation fertilizers: water-soluble fertilizer (product of ICL Specialty Fertilizers, mixture of urea, monoammonium phosphate and potassium chloride)

Apparatus: Rice fertigation device of present disclosure as shown in FIG. 1-3. 2 apparatuses were located next to 2 hydrants at 0.34 ha of rice field. H1=38 cm, H2=70 cm, volume of liquid composition per apparatus=50 L, It took about 5 hours to dispense 50 L of the liquid composition.

Fertilization Program (kg/ha):

| | Base | | |
|---|---|---|---|
| | fertilizer | None | Total |
| Treatment | 1^{st} | N 12.5 kg, P₂O₅ 7.5 kg, K₂O | N 50 kg |
| field | (June 13th) | 10 kg | P₂O₅ 30 kg |
| (Fertigation) | 2^{nd} (July 4th) | N 12.5 kg, P₂O₅ 7.5 kg, K₂O | K₂O 40 kg |
| | | 10 kg | |
| | 3^{rd} | N 12.5 kg, P₂O₅ 7.5 kg, K₂O | |
| | (July 25th) | 10 kg | |
| | 4^{th} (August | N 12.5 kg, P₂O₅ 7.5 kg, K₂O | |
| | 12th) | 10 kg | |

The apparatus used was proven to distribute nutrients evenly throughout rice field, showing uniform plant height and leaf color. It is economical, trouble-free, user-friendly and accurate to operate. It is expected to reduce fertilizer input via the apparatus to maintain yield level, comparing to conventional granular fertilizer application.

The following numbered paragraphs set out particular combinations of features which are considered relevant to particular embodiments of the present disclosure.
1. An apparatus configured to dispense a liquid composition to irrigation water for use in surface irrigation, said apparatus comprising:
   a reservoir tank having the liquid composition to be dispensed therein;
   wherein the reservoir tank comprises an outlet connection in communication with an emitter means,
   wherein the reservoir tank, the emitter means, and/or the apparatus are configured to dispense only the liquid composition.
2. The apparatus of any of the paragraphs, wherein the apparatus is arranged not to receive a continuous supply of the irrigation water during operation, but to receive a batch supply of the liquid composition into the reservoir tank before operation or to receive a batch supply of a solvent/liquid medium and a batch supply of a product into the reservoir tank before operation.
3. The apparatus of any of the paragraphs, wherein the apparatus is configured to dispense the liquid composition comprising a product having mass concentration of at least 5% (w/w).
4. The apparatus of any of the paragraphs, wherein the apparatus is configured to dispense the liquid composition, which is a solution or suspension of a fertilizer and/or an agrochemical in a liquid medium.
5. The apparatus of any of the paragraphs, wherein the emitter means is placed outside of the irrigation water and the perpendicular distance between bottom surface of the reservoir tank and the emitter means is about 50 cm or higher than 50 cm, measured along a line that is perpendicular to both or wherein the emitter means dispense the liquid composition at pressure of about 0.05 bar or higher than about 5 bar.
6. The apparatus of any of the paragraphs, wherein the emitter means is immersed in the irrigation water or placed on the surface of the irrigation water and the perpendicular distance between bottom surface of the reservoir tank and surface of the irrigation water is about 50 cm or higher than about 50 cm, measured along a line that is perpendicular to both or wherein the emitter means dispense the liquid composition at pressure of about 0.05 bar or higher than about 5 bar.
7. The apparatus of any of the paragraphs, wherein the emitter means is configured to dispense the liquid composition at a flow rate of the liquid composition determined according to formula I:

Fₜ=F₁×V₁+F₂×V₂ . . . +Fₙ×Vₙ (I)
wherein,
“Fₜ” is a total flow rate of the liquid composition per hour dispensed from total emitter means of the apparatus in operation;
“F₁” is a flow rate per hour of the first emitter means for water at a given pressure; “V₁” is viscosity coefficient of the first emitter means for the liquid composition;
“F₂” is a flow rate per hour of the second emitter means for water at a given pressure;
“V₂” is viscosity coefficient of the second emitter mean for the liquid composition.
“Fₙ” is a flow rate per hour of n^{th} emitter means for water at given pressure;
“Vₙ” is viscosity coefficient of the n^{th} emitter means for the liquid composition.
8. The apparatus of claim paragraphs, wherein the pressure is determined according to Formula II:

P=D×g×H (II)
wherein,
“P”=pressure (in Pa);
“D”=Density of the liquid composition (in kg/m³);
“g”=gravity constant (typically 9.8 m/s²)
“H”=total height (in m)
wherein if the emitter means is located outside of irrigation water, the total height is a perpendicular distance between surface of the liquid composition in the reservoir tank and the emitter means, measured along a line that is perpendicular to both, or
if the emitter means is immersed in irrigation water, total height is a perpendicular distance between surface of the liquid composition in the reservoir tank and surface of irrigation water, measured along a line that is perpendicular to both.
9. The apparatus of any of the paragraphs, wherein the emitter means is an on-line dripper and/or an integral tube dripper.
10. The apparatus of any of the paragraphs, wherein the apparatus further comprises irrigation water used for surface irrigation.
11. A method for dispensing a liquid composition to irrigation water for use in surface irrigation of a crop and/or a plant, said method comprising: dosing a liquid composition in a reservoir tank via an emitter means to irrigation water used for surface irrigation of a crop and/or a plant; wherein the reservoir tank, the emitter means, and/or the apparatus are configured to dispense only the liquid composition.
12. The method of any of the paragraphs, wherein the apparatus is arranged not to receive a continuous supply of the irrigation water during operation, but to receive a batch supply of the liquid composition into the reservoir tank before operation or to receive a batch supply of a solvent/liquid medium and a batch supply of a product into the reservoir tank before operation.
13. The method of any of the paragraphs, wherein the liquid composition comprises a product having mass concentration of at least about 5% (w/w).
14. The method of any of the paragraphs, wherein the dosed liquid composition is a solution or suspension of a fertilizer and/or an agrochemical in a liquid medium.
15. The method of any of the paragraphs, wherein the emitter means is placed outside of the irrigation water and the perpendicular distance between bottom surface of the reservoir tank and the emitter means is about 50 cm or higher than 50 cm, measured along a line that is perpendicular to both or wherein the emitter means dispense the liquid composition at pressure of about 0.05 bar or higher than about 0.05 bar.
16. The method of any of the paragraphs, wherein the emitter means is immersed in the irrigation water or placed on the surface of the irrigation water and the perpendicular distance between bottom surface of the reservoir tank and surface of the irrigation water is about 50 cm or higher than about 50 cm, measured along a line that is perpendicular to both or wherein the emitter means dispense the liquid composition at pressure of about 0.05 bar or higher than about 0.05 bar.
17. The method of any of the paragraphs, wherein the emitter means is configured to dispense the liquid composition at a flow rate of the liquid composition determined according to formula I:

Fₜ=F₁×V₁+F₂×V₂ . . . +Fₙ×Vₙ (I)
wherein,
“Fₜ” is a total flow rate of the liquid composition per hour dispensed from total emitter means of the apparatus in operation;
“F₁” is a flow rate per hour of the first emitter means for water at a given pressure; “V₁” is viscosity coefficient of the first emitter means for the liquid composition;
“F₂” is a flow rate per hour of the second emitter means for water at a given pressure;
“V₂” is viscosity coefficient of the second emitter mean for the liquid composition.
“Fₙ” is a flow rate per hour of n^{th} emitter means for water at given pressure;
“Vₙ” is viscosity coefficient of the n^{th} emitter means for the liquid composition.
18. The method of any of the paragraphs, wherein the pressure is determined according to Formula II:

P=D×g×H (II)
wherein,
“P”=pressure (in Pa);
“D”=Density of the liquid composition (in kg/m³);
“g”=gravity constant (typically 9.8 m/s²)
“H”=total height (in m)
wherein if the emitter means is located outside of irrigation water, the total height is a perpendicular distance between surface of the liquid composition in the reservoir tank and the emitter means, measured along a line that is perpendicular to both, or
if the emitter means is immersed in irrigation water, total height is a perpendicular distance between surface of the liquid composition in the reservoir tank and surface of irrigation water, measured along a line that is perpendicular to both.
19. The method of any of the paragraphs, wherein the emitter means is an on-line dripper and/or an integral tube dripper.
20. The method of any of the paragraphs, wherein the liquid composition is dispensed to a basin irrigated rice field.
21. Use of the apparatus and/or method of any of the paragraphs for dispensing a liquid composition to the irrigation water used for surface irrigation, preferably basin irrigation, more preferably basin irrigation of crops and/or plants.
22. The use of the apparatus and/or method of any of the paragraphs, wherein the apparatus and/or method of any of the preceding claim is used for dispensing the liquid composition to the irrigation water used for basin irrigation of paddy rice field, preferably, the liquid composition comprises a fertilizer and/or an agrochemical.
23. The use of any of the preceding the apparatus and/or method of any of the paragraphs, wherein the used emitter means is online dripper and/or an integral dipper.

What is claimed is:

1. An apparatus configured to dispense a liquid composition to irrigation water for use in surface irrigation, said apparatus comprising:
a reservoir tank having the liquid composition to be dispensed therein;
wherein the reservoir tank comprises an outlet connection in communication with an emitter means;
wherein the apparatus is configured to dispense only the liquid composition to irrigation water.

2. The apparatus of claim 1, wherein the apparatus is arranged not to receive a continuous supply of the irrigation water during operation, but to receive a batch supply of the liquid composition into the reservoir tank before operation or to receive a batch supply of a solvent and a batch supply of a product into the reservoir tank before operation.

3. The apparatus of claim 2, wherein the apparatus is configured to dispense the liquid composition, which is a solution or suspension of a product comprising a fertilizer and/or an agrochemical in a liquid medium.

4. The apparatus of claim 3, wherein the apparatus is configured to dispense the liquid composition comprising the product having mass concentration of at least 5% (w/w).

5. The apparatus of claim 4, wherein the emitter means is configured to dispense the liquid composition at a flow rate of the liquid composition determined according to formula I:
Fₜ=Fₜ×V₁+F₂×V₂ . . . +Fₙ×Vₙ (I)
wherein,
“Fₜ” is a total flow rate of the liquid composition per hour dispensed from total emitter means of the apparatus in operation;
“F₁” is a flow rate per hour of the first emitter means for water at a given pressure;
“V₁” is viscosity coefficient of the first emitter means for the liquid composition;
“F₂” is a flow rate per hour of the second emitter means for water at a given pressure;
“V₂” is viscosity coefficient of the second emitter mean for the liquid composition.
“Fₙ” is a flow rate per hour of n^{th} emitter means for water at given pressure;
“Vₙ” is viscosity coefficient of the n^{th} emitter means for the liquid composition.

6. The apparatus of claim 5, wherein the pressure is determined according to Formula II:
P=D×g×H (II)
wherein,
“P”=pressure (in Pa);
“D”=Density of the liquid composition (in kg/m³);
“g”=gravity constant (typically 9.8 m/s²)
“H”=total height (in m)
wherein if the emitter means is located outside of irrigation water, the total height is a perpendicular distance between surface of the liquid composition in the reservoir tank and the emitter means, measured along a line that is perpendicular to both, or
if the emitter means is immersed in irrigation water, total height is a perpendicular distance between surface of the liquid composition in the reservoir tank and surface of irrigation water, measured along a line that is perpendicular to both.

7. The apparatus of claim 4, wherein the emitter means is an on-line dripper and/or an integral tube dripper.

8. The apparatus of claim 7, wherein the emitter means is placed outside of the irrigation water and the perpendicular distance between bottom surface of the reservoir tank and the emitter means is about 50 cm or higher than about 50 cm, measured along a line that is perpendicular to both or wherein the emitter means dispense the liquid composition at pressure of about 0.05 bar or higher than about 0.05 bar.

9. The apparatus of claim 7, wherein the emitter means is immersed in the irrigation water or placed on the surface of the irrigation water and the perpendicular distance between bottom surface of the reservoir tank and surface of the irrigation water is about 50 cm or higher than about 50 cm, measured along a line that is perpendicular to both or wherein the emitter means dispense the liquid composition at pressure of about 0.05 bar or higher than about 0.05 bar.

10. The apparatus of claim 7, wherein the apparatus further comprises irrigation water used for surface irrigation.

11. A method for dispensing a liquid composition to irrigation water for use in surface irrigation, said method comprising:
dosing a liquid composition from a reservoir tank via an emitter means to irrigation water used for surface irrigation of a crop and/or a plant;
wherein the apparatus is configured to dispense only the liquid composition.

12. The method of claim 11, wherein the apparatus is arranged not to receive a continuous supply of the irrigation water during operation, but to receive a batch supply of the liquid composition into the reservoir tank before operation or to receive a batch supply of a solvent and a batch supply of a product into the reservoir tank before operation.

13. The method of claim 12, wherein the apparatus is configured to dispense the liquid composition, which is a solution or suspension of a product comprising a fertilizer and/or an agrochemical in a liquid medium.

14. The method of claim 13, wherein the apparatus is configured to dispense the liquid composition comprising the product having mass concentration of at least 5% (w/w).

15. The method of claim 14, wherein the emitter means is configured to dispense the liquid composition at a flow rate of the liquid composition determined according to formula I:
Fₜ=F₁×V₁+F₂×V₂ . . . +Fₙ×Vₙ (I)
wherein,
“Fₜ” is a total flow rate of the liquid composition per hour dispensed from total emitter means of the apparatus in operation;
“F₁” is a flow rate per hour of the first emitter means for water at a given pressure;
“V₁” is viscosity coefficient of the first emitter means for the liquid composition;
“F₂” is a flow rate per hour of the second emitter means for water at a given pressure;
“V₂” is viscosity coefficient of the second emitter mean for the liquid composition.
“Fₙ” is a flow rate per hour of n^{th} emitter means for water at given pressure;
“Vₙ” is viscosity coefficient of the n^{th} emitter means for the liquid composition.

16. The method of claim 15, wherein the pressure is determined according to Formula II:
P=D×g×H (II)
wherein,
“P”=pressure (in Pa);
“D”=Density of the liquid composition (in kg/m³);
“g”=gravity constant (typically 9.8 m/s²)
“H”=total height (in m)
wherein if the emitter means is located outside of irrigation water, the total height is a perpendicular distance between surface of the liquid composition in the reservoir tank and the emitter means, measured along a line that is perpendicular to both, or
if the emitter means is immersed in irrigation water, total height is a perpendicular distance between surface of the liquid composition in the reservoir tank and surface of irrigation water, measured along a line that is perpendicular to both.

17. The method of claim 14, wherein the emitter means is an on-line dripper and/or an integral tube dripper.

18. The method of claim 17, wherein the emitter means is placed outside of the irrigation water and the perpendicular distance between bottom surface of the reservoir tank and the emitter means is about 50 cm or higher than about 50 cm, measured along a line that is perpendicular to both or wherein the emitter means dispense the liquid composition at pressure of about 0.05 bar or higher than about 0.05 bar.

19. The method of claim 17, wherein the emitter means is immersed in the irrigation water or placed on the surface of the irrigation water and the perpendicular distance between bottom surface of the reservoir tank and surface of the irrigation water is about 50 cm or higher than about 50 cm, measured along a line that is perpendicular to both or wherein the emitter means dispense the liquid composition at pressure of about 0.05 bar or higher than about 0.05 bar.

20. The method of claim 17, wherein the liquid composition is dispensed to a basin irrigated rice field.
